(19) United States
(12) Patent Application Publication
(10) Pub. No.: US 2004/0228792 A1
(43) Pub. Date: Nov. 18, 2004

(54) Catalyst comprising two catalytically-active metals

(76) Inventors: Gerrit Jan Barend Assink, Amsterdam (NL); Hans Michiel Huisman, Amsterdam (NL); Gert Jan Kramer, Amsterdam (NL); Ronald Jan Schoonebeek, Amsterdam (NL); Wim Wieldraaijer, Amsterdam (NL)

Correspondence Address: Jennifer D. Adamson, Shell Oil Company, Legal - Intellectual Property, P.O. Box 2463, Houston, TX, 77252-2463, US

(21) Appl. No.: 10/600,494

(22) Filed: Jun. 7, 2004

Related U.S. Application Data
(62) Division of application No. 09/720,288, filed on Dec. 21, 2000, now abandoned.

(30) Foreign Application Priority Data
Jun. 30, 1998 (EP) 98305179.8

(51) Int. Cl. C01B 3/26

(52) U.S. Cl. 423/651

(57) ABSTRACT

The invention relates to a catalyst or a precursor therefor in the form of a fixed arrangement, wherein the fixed arrangement comprises at least two layers, the first layer comprising as a catalytically active metal or precursor therefor rhodium or a rhodium compound and the second layer comprising as a catalytically active metal or precursor therefor iridium, osmium or platinum or a compound thereof. The invention also relates to catalyst particles or catalyst precursor particles comprising a first, outer layer comprising as a catalytically active metal or precursor therefor rhodium or a rhodium compound and a second layer comprising as a catalytically active metal or precursor therefor iridium, osmium or platinum or a compound thereof. The invention further relates to the use of the catalyst or the catalyst particles, especially in a process for the catalytic partial oxidation of a hydrocarboneous feedstock.

The present invention relates to a catalyst or a precursor therefor in the form of a fixed arrangement, to catalyst particles or catalyst precursor particles, and to the use of the catalyst or the catalyst particles, especially in a process for the catalytic partial oxidation of a hydrocarboneous feedstock.

The partial oxidation of hydrocarbons, for example methane or natural gas, in the presence of a catalyst is an attractive route for the preparation of mixtures of carbon monoxide and hydrogen, known in the art as synthesis gas. The partial oxidation of a hydrocarbon is an exothermic reaction and, in the case in which methane is the hydrocarbon, proceeds by the following reaction:

$$2 C {H}_{4} + {O}_{2} ⟶ 2 C O + 4 {H}_{2}$$

The optimum catalytic partial oxidation process for application on a commercial scale would give high yields of carbon monoxide and hydrogen at elevated pressures, for example in the range of from 15 to about 60 bar, and high space velocities, for example of the order of 1,000,000 Nl/kg/h or more. In order to obtain high yields of carbon monoxide and hydrogen under these process conditions, it is for thermodynamic reasons preferred to operate the partial oxidation process at relatively high temperatures.

The literature contains a number of documents disclosing details of experiments relating to the catalytic oxidation of hydrocarbons, in particular methane, employing a wide range of catalysts

In U.S. Pat. No. 5,149,464, for example, is disclosed the selective oxygenation of methane to carbon monoxide and hydrogen by contacting the reactant gas mixture at a temperature of about 650° C. to 900° C., preferably 700° C. to 800° C. and a pressure of about 10 to about 600 kPa with a solid, mixed oxide catalyst. It is stated in U.S. Pat. No. 5,149,464 that the preferred metals are those in Group VIII of the Periodic Table of the Elements. Catalysts including ruthenium oxide, praesidium/ruthenium oxides, pyrochlores, ruthenium on alumina, rhodium on alumina, palladium on alumina, platinum on alumina, nickel/aluminium oxide, perovskites and nickel oxide are exemplified.

A similar general disclosure of a catalyst for use in the catalytic partial oxidation process is made in WO 92/11199. In this document experiments are disclosed in which catalysts comprising iridium, palladium, ruthenium, rhodium, nickel or platinum supported on alumina were employed for partial oxidation under mild process conditions, the pressure of 1 atmosphere, a temperature of 1050 K (777° C.) and a gas hourly space velocity of about 20,000 h⁻¹.

However, to be commercially attractive, a catalytic partial oxidation process should operate at relatively severe conditions, i.e. the combination of high pressure, high temperature and high hourly space velocity. An important factor when considering a catalyst for application in a commercial process, is the stability of that catalyst under the prevailing process conditions. The relatively mild conditions under which the experiments reported in the above-mentioned prior art documents have been conducted do not provide an insight into the stability of the various catalyst compositions under the severe process conditions needed for commercial implementation.

The literature further contains a number of documents disclosing details of experiments relating to the catalytic partial oxidation of hydrocarbons under conditions required for commercial operation to produce mixtures of carbon monoxide and hydrogen.

EP-A-0 629 578 discloses that, at a temperature of at least 950° C. and at a very high gas hourly space velocity, a marked difference in the stability of the Group VIII metal catalysts exists. It has been found that catalysts comprising rhodium, iridium or ruthenium display a significantly higher stability in terms of both selectivity and activity than the remaining Group VIII metal catalysts.

U.S. Pat. No. 5,648,582 concerns a catalytic partial oxidation process at very high gas hourly space velocity and at a catalyst temperature in the range of from 850 to 1150° C. using a catalyst comprising rhodium, nickel or platinum. In the examples, it is shown that a catalyst comprising rhodium performs better than a catalyst comprising platinum.

WO 97/37929 concerns equipment for carrying out catalytic partial oxidation reactions. It is mentioned that a catalyst bed having a first layer comprising rhodium and a second layer comprising ruthenium or nickel may be used, in order to reduce the amount of rhodium used.

Although ruthenium and nickel are relatively cheap materials and therefore attractive for the use as catalytically-active metals, a major disadvantage of the use of ruthenium or nickel in catalytic partial oxidation is, however, that a relatively large amount of undesired trace components such as ammonia and hydrogen cyanide is formed.

In WO 95/18063, for example, it is disclosed that partial oxidation catalysts comprising rhodium, iridium or platinum as the catalytically-active metal, generate significantly lower amounts of ammonia and hydrogen cyanide than catalysts comprising other catalytically-active metals. It is shown in the examples that a ruthenium-containing catalyst generates a relatively large amount of ammonia and hydrogen cyanide.

Thus, catalysts comprising rhodium or iridium as the catalytically-active metal are preferred. But there still exists a problem in the art in that catalysts comprising either rhodium or iridium slowly deactivate under the severe process conditions required for commercial operation to produce mixtures of carbon monoxide and hydrogen.

Surprisingly, it has now been found that the stability of a catalyst arrangement can be improved by using a combination of two catalytically-active metals in two different layers. In particular, it has been found that a catalyst in the form of a fixed arrangement, wherein a first layer comprises rhodium as the catalytically-active metal and a second layer comprises either iridium, osmium or platinum as the catalytically-active metal, shows a slower deactivation rate than a catalyst comprising either rhodium, iridium, osmium or platinum as the catalytically-active metal or comprising a combination thereof in one single layer.

Thus, the present invention relates to a catalyst or a precursor therefor in the form of a fixed arrangement, wherein the fixed arrangement comprises at least two layers, the first layer comprising as a catalytically-active metal or precursor therefor rhodium or a rhodium compound and the second layer comprising as a catalytically active metal or precursor therefor iridium, osmium or platinum or a compound thereof.

Reference herein to a first layer is to a layer at the first side of the fixed arrangement, preferable to a layer which is, under operating conditions, situated at the upstream side of the fixed arrangement, more preferable at the upstream end of the fixed arrangement. The second layer is then (under operating conditions) situated downstream of the first layer, suitably adjacent to the first layer. There may be a small gap, i.e. a small layer containing none of the catalytically active metals of one of the layers, between the first and the second layer. Small is suitably to be construed as having a length substantially smaller than the length of the first layer, i.e. at most 50%, or especially at most 20% of the length of the first layer. Preferably there is no gap between the first and the second layer. The fixed arrangement may contain more than two layers, but a two-layer arrangement is preferred.

The fixed arrangement may have any suitable form, provided that the arrangement is permeable to a fluid, especially to gas. Preferably the fixed arrangement is in the form of a fixed bed of particles or in the form of a porous monolithic structure. The fixed arrangement may also be in the form of wires or gauzes of the catalytically-active metal.

If the fixed arrangement is in the form of a fixed bed of catalyst particles, the bed contains, suitably at its upstream side, a first layer filled with catalyst (precursor) particles comprising rhodium or a rhodium compound as the catalytically-active metal (precursor), and (suitably at the downstream side of the first layer, preferably adjacent hereto) a second layer filled with particles comprising iridium, osmium or platinum or a compound thereof as the catalytically-active metal (precursor).

In an alternative embodiment, the fixed arrangement of the present invention is in the form of at least one porous monolithic structure, preferably in the form of one porous monolithic structure. Reference herein to a porous monolithic structure is to any single porous material unit, e.g. a metal or, especially, a refractory material unit, in which the pores constitute straight or tortuous, parallel or random elongate channels extending through the unit structure, i.e. having interconnected open-porosity. Reference herein to pores is to openings or spaces between adjacent portions or lands of the monolithic structure. Thus, it will be appreciated that the pores referred to in respect of the present invention have a nominal diameter of the order of magnitude of 0.05 to 5 mm. These are to be contrasted with the smaller pores, including micro- and mesopores, which may be present in the catalyst support material itself.

The porous monolithic structure may have any suitable form. One form of monolithic porous structure is that of a honeycomb. Honeycombs are characterised by having a plurality of straight, elongate, parallel channels extending through the structure. Preferred porous monolithic structures are ceramic foams. Suitable ceramic foams are available commercially, for example from Selee Inc., Hi-Tech and Dytech. Preferred ceramic foams have a number of pores per cm in the range of from 20 to 120, more preferably in the range of from 25 to 100 pores per cm. Reference herein to the number of pores per cm is to the number of pores counted alongside a bar of 1 cm which is laid on the monolithic structure. A preferred method of measuring this is by using an enlarged photograph. In case of an uneven distribution of pores over the monolithic structure, reference herein to number of pores is to the number of pores averaged over different directions.

The porous monolithic structure or the fixed arrangement comprising more than one porous monolithic structure may have any shape. Suitably, the downstream end of the monolithic structure is co-planar with the upstream end.

The fixed arrangement suitably has a void fraction in the range of 0.4 to 0.95, preferably in the range of 0.6 to 0.9.

The second layer of the fixed arrangement has a length which is suitably at least equal to the length of the first layer, typically the second layer is longer than the first layer. Preferably, the length of the second layer is at least two times the length of the first layer, more preferably at least three times, even more preferably at least four times. The length of the second layer is at most 50 times the length of the first layer, preferably at most 20 times. Preferably, each layer has a constant length over its whole width. Reference herein to the length and the width of the arrangement is to the dimensions in the direction parallel and perpendicular to the central longitudinal axis of the arrangement, respectively.

The first layer may have a length in the range of from 0.1 mm to 100 mm, preferably of from 0.2 to 50 mm, more preferably of from 1 to 30 mm. Typically, the total length of the fixed arrangement is in the range of from 2 mm to 300 mm, preferably of from 5 mm to 100 mm.

The present invention further relates to catalyst particles or catalyst precursor particles comprising a first, outer layer comprising as a catalytically active metal or precursor therefor rhodium or a rhodium compound and a second layer comprising as a catalytically active metal or precursor therefor iridium, osmium or platinum or a compound thereof. These catalyst particles may be used either in a fixed bed of particles or in a fluidised bed regime.

The first layer of the fixed arrangement or catalyst (precursor) particles of the present invention comprises rhodium or a rhodium compound as the catalytically active metal or precursor therefor. The second layer comprises iridium, osmium or platinum (or a compound thereof) as the catalytically active metal (or precursor therefor), preferably iridium or an iridium compound.

Although the catalytically-active metals of the fixed arrangement of catalyst may be present in the form of metal wires or gauzes, the catalytically-active metals are preferably supported on a carrier material.

In the case of supported catalytically-active metals, each layer may comprise the catalytically active metal in any suitable amount to achieve the required level of activity. Typically, each catalyst layer comprises the active metal in an amount in the range of from 0.02 to 10% by weight, more preferably from 0.1 to 7.5% by weight based on the weight of the carrier material. The metal concentration typically is constant throughout each layer. Optionally, the first layer may also comprise the catalytically active metal of the second layer, i.e. iridium, osmium or platinum additionally to rhodium.

In an alternative embodiment of the invention, the concentration of the catalytically active metal of the first layer, i.e. rhodium, gradually decreases in one direction of the fixed arrangement and the concentration of the catalytically active metal of the second layer, i.e. iridium, osmium or platinum, gradually decreases in the other direction of the fixed arrangement.

The particles forming the fixed bed or the porous monolithic structure of the invention may be provided with the catalytically active metals or precursors therefor by processes known in the art. Suitable processes are impregnation or washcoating of the particles or the porous monolithic structure with the catalytically active material or a precursor thereof. Impregnation typically comprises contacting the particles or monolithic structure with a solution of a compound of the catalytically active material or precursor thereof, followed by drying and calcining the resulting material. In the case of a porous monolithic structure, the structure may be sequentially impregnated or washcoated with two different solution, each containing a different catalytically active metal compound. The layer that should not be impregnated may be provided with a wax or another material that prevents impregnation. Partial impregnation or washcoating is another possibility.

Catalyst particles comprising a first, outer rhodium-containing layer and a second, iridium, osmium or platinum-containing layer may be prepared by impregnation or washcoating with the compound of the catalytically active metal of the second layer, followed by a subsequent impregnation or washcoating with rhodium or a rhodium compound.

The catalytically active metal or precursor thereof in at least one of the layers may be associated with at least one inorganic metal cation or a precursor thereof in such a way that the inorganic metal cation is present in intimate association, supported on or with the catalytically active metal.

The cation is selected from Groups IIA, IIIA, IIIB, IVA and IVB of the Periodic Table and the lanthamides for example Al, Mg, Zr, Ti, La, Hf, Si and Ba, of which Zr is preferred. The cation is preferably in the form of its oxide.

Reference herein to intimate association of the cation is to its incorporation in suitable manner on or with the metal thereby modifying the catalytic performance properties thereof.

Suitably therefore the cation is present on the surface of the catalyst. Preferably the catalyst comprises cation to metal in a ratio in excess of or equal to 1.0 at its surface, preferably in excess of or equal to 2.0 more preferably in excess of or equal to 3.0 up to a maximum only limited by the constraints of the method for constructing the catalyst, e.g. impregnation.

The catalytically active metal and metal cation are essentially present as an intimate admixture or layers which resemble an admixture. Preferably the metal cation is present substantially as a single layer or powder particle, in intimate admixture with the supported or unsupported catalytically active metal. The layer may be present throughout the catalyst surface or may be present only in certain regions of the catalyst bed, for example in the leading edge of a fixed bed.

The thickness of a layer of metal cation as hereinbefore defined may be selected for optimum effect and may be determined by measurement of the selectivity of reaction and the like. Thickness is conveniently in the order of microns.

The catalytically active metals or precursors therefor are suitably supported on particles or a porous monolithic structure of carrier material. Preferably the carrier material is an inorganic material of high temperature resistance, more preferably a refractory oxide, such as alumina, silica, zirconia, titania or mixtures thereof. The choice of carrier material will generally depend on the intended use. Even more preferably the carrier material is zirconia-based. Any suitable zirconia-based material may be employed. The material preferably comprises at least 70% by weight zirconia, for example selected from known forms of (partially) stabilised zirconia or substantially pure zirconia. (Partially) stabilised zirconia comprising oxides of one or more of the rare earth, Group IIIB or Group IIA elements of the Periodic Table of the Elements are particularly preferred zirconia-based materials. References herein to the Periodic Table of the Elements are to the CAS version, as published in the CRC Handbook of Chemistry and Physics, 68th Edition. Most preferred zirconia-based materials comprise zirconia stabilised or partially-stabilised by one or more oxides of Mg, Ca, Al, Y, La or Ce. Most suitable carrier materials are Ce-ZTA (zirconia-toughened alumina) and Y—PSZ (partially-stabilised zirconia), both commercially available.

The present invention further relates to a process for the catalytic partial oxidation of a hydro-carbonaceous feedstock, which comprises contacting a feed comprising a hydrocarbonaceous feedstock and an oxygen-containing gas with a catalyst in a fixed arrangement or with catalyst particles as hereinbefore defined, preferable at a pressure in the range of from 2 to 150 bara, at a temperature in the range of from 750 to 1400° C., and at a gas hourly space velocity in the range of from 20,000 to 100,000,000 Nl/kg/h. Reference herein to temperature is to the temperature of the gas leaving the catalyst.

The preferred process is suitably used to prepare a mixture of carbon monoxide and hydrogen from any hydrocarbonaceous feedstock. This process is a means to obtain very useful products known in the art as synthesis gas by means of an exothermic reaction, by which the molar ratio of carbon monoxide to hydrogen in the products may be controlled by means of choice of feedstock and operating conditions to give a desired molar ratio of carbon monoxide to hydrogen in the products.

The hydrocarbonaceous feedstock is in the gaseous phase when contacting the catalyst. The feedstock may contain compounds that are liquid and/or compounds that are gaseous under standard conditions of temperature and pressure (i.e. at 0° C. and 1 atm.).

The process is particularly suitable for the partial oxidation of methane, natural gas, associated gas or other sources of light hydrocarbons. In this respect, the term “light hydrocarbons” is a reference to hydrocarbons having from 1 to 5 carbon atoms. The process may be advantageously applied in the conversion of gas from naturally occurring reserves of methane which contain substantial amounts of carbon dioxide. The feed preferably comprises methane in an amount of at least 50% by volume, more preferably at least 70% by volume, especially at least 80% by volume.

The process is also suitable for the conversion of feedstocks being gaseous when contacting the catalyst during operation, but being liquid under standard conditions of temperature and pressure. Typically, these feedstocks have an average carbon number of at least 6 and contain up to 25 carbon atoms in their molecules, for example feedstocks boiling in the range of from 50° C. to 500° C., preferably in the range of from 60° C. to 350° C. The process is particular suitable for the partial oxidation of kerosene feedstocks boiling between 150° C. and 200° C. or synthetic gas oil feedstocks boiling between 200° C. and 500° C., in particular between 200° C. and 300° C.

It is possible to have hydrocarbonaceous material present in the feedstocks which is gaseous under standard conditions of temperature and pressure, together with material which is liquid under standard conditions of temperature and pressure and having an average carbon number of at least 6.

The process according to the present invention can also be carried out when the feedstock contains oxygenates (being gaseous, and having less than 6 carbon atoms, and/or being liquid under standard condition of temperature and pressure and having an average carbon number of at least 6). Oxygenates to be used as (part of) the feedstock in the process according to the present invention are defined as molecules containing apart from carbon and hydrogen atoms at least 1 oxygen atom which is linked to either one or two carbon atoms or to a carbon atom and a hydrogen atom. Examples of suitable oxygenates comprise methanol, ethanol, dimethyl ether and the like, having less than 6 carbon atoms, and alkanols, ether, acids and esters having between 6 and 25 carbon atoms and being liquid under standard conditions of temperature and pressure.

Also mixtures of hydrocarbons and oxygenates as defined hereinbefore can be used as feedstock in the process according to the present invention.

The hydrocarbonaceous feedstock is contacted with the catalyst as a mixture with an oxygen-containing gas. Suitable oxygen-containing gases are air, oxygen-enriched air or pure oxygen. The use of air as the oxygen-containing gas is preferred. The feed mixture may optionally comprise steam. Optionally, the feed mixture may comprise carbon dioxide in a concentration of up to 60% by volume of the total feed mixture.

The hydrocarbonaceous feedstock and the oxygen-containing gas are preferably present in the feed in such amounts as to give an oxygen-to-carbon ratio in the range of from 0.3 to 0.8, more preferably, in the range of from 0.45 to 0.75. References herein to the oxygen-to-carbon ratio refer to the ratio of oxygen in the form of molecules (O₂) to carbon atoms present in the hydrocarbon feedstock. Oxygen-to-carbon ratios in the region of the stoichiometric ratio of 0.5, i.e. ratios in the range of from 0.45 to 0.65, are especially preferred. If steam is present in the feed, the steam-to-carbon ratio is preferably in the range of from above 0.0 to 3.0, more preferably from 0.0 to 2.0. The hydrocarbonaceous feedstock, the oxygen-containing gas and steam, if present, are preferably well mixed prior to being contacted with the catalyst. The feed mixture is preferably preheated prior to contacting the catalyst.

The feed is preferably contacted with the catalyst under adiabatic conditions. For the purposes of this specification, the term “adiabatic” is a reference to reaction conditions under which substantially all heat loss and radiation from the reaction zone are prevented, with the exception of heat leaving in the gaseous effluent stream of the reactor.

The process of the present invention may be operated at any suitable pressure. For applications on a commercial scale, elevated pressures, that is pressures significantly above atmospheric pressure are most suitably applied. The process may be operated at pressures in the range of from 1 to 150 bara. Preferably, the process is operated at pressures in the range of from 2 to 100 bara, especially from 5 to 50 bara.

Under the preferred conditions of high pressure prevailing in processes operated on a commercial scale, the feed is preferably contacted with the catalyst at a temperature in the range of from 850 to 1350° C., more preferably of from 900 to 1300° C.

The feed may be provided during the operation of the process at any suitable space velocity. It is an advantage of the process of the present invention that very high gas space velocities can be achieved. Thus, gas space velocities for the process (expressed in normal litres of gas per kilogram of catalyst per hour, wherein normal litres refers to litres under STP conditions, i.e. 0° C. and 1 atm.) are in the range of from 20,000 to 100,000,000 Nl/kg/h, more preferably in the range of from 50,000 to 50,000,000 Nl/kg/h. Space velocities in the range of from 500,000 to 30,000,000 Nl/kg/h are particularly suitable for use in the process.

The invention will now be illustrated further by means of the following Examples.

### EXAMPLE 1 (Comparative)

Catalyst Preparation

A foam containing 25 pores per cm (65 ppi) was crushed and the 0.17-0.55 mm particles (30-80 mesh fraction) were impregnated by immersion in an aqueous solution containing 7.8 wt % rhodium (as rhodium trichloride) and 11.2 wt % zirconium (as zirconium nitrate). The impregnated particles were dried at 140° C. and subsequently calcined at 700° C. for 2 hours. The resulting catalyst particles (catalyst A) comprised 5% by weight rhodium and 7% by weight zirconium based on the total weight of the calcined catalyst particles.

Catalytic Partial Oxidation

A 6 mm diameter reactor tube was filled with 0.5 g of the rhodium-containing catalyst particles prepared as hereinbefore described. Nitrogen (914 Nl/h), oxygen (440 Nl/h), and methane (440 Nl/h) were thoroughly mixed and preheated to a temperature of 300° C. The preheated mixture was fed to the reactor at a pressure of 11 bara. The methane conversion was monitored for 150 hours. The temperature of the gas leaving the catalyst bed was between 930 and 950° C.

### EXAMPLE 2 (Comparative)

Catalyst Preparation

A foam containing 25 pores per cm (65 ppi) was crushed and the 0.17-0.55 mm particles (30-80 mesh fraction) were impregnated by immersion in an aqueous solution of iridium chloride and zirconium nitrate. The impregnated particles were dried at 140° C. and subsequently calcined at 700° C. for 2 hours. The resulting catalyst particles comprised 5% by weight iridium and 7% by weight zirconium based on the total weight of the calcined catalyst particles.

Catalytic Partial Oxidation

A 6 mm diameter reactor tube was filled with 0.5 g of the iridium-containing catalyst particles prepared as hereinbefore described. A catalytic partial oxidation experiment was performed using the same procedure as described in Example 1. The methane conversion was monitored for 250 hours. The temperature of the gas leaving the catalyst bed was between 930 and 950° C.

### EXAMPLE 3 (According to the Invention)

Catalytic Partial Oxidation

A 6 mm diameter reactor tube was filled with 0.1 g of rhodium-containing catalyst particles on top of 0.4 g of iridium-containing catalyst particles prepared as hereinbefore described. A catalytic partial oxidation experiment was performed using the same procedure as described in Example 1. The methane conversion was monitored for 250 hours. The temperature of the gas leaving the catalyst bed was between 930 and 950° C.

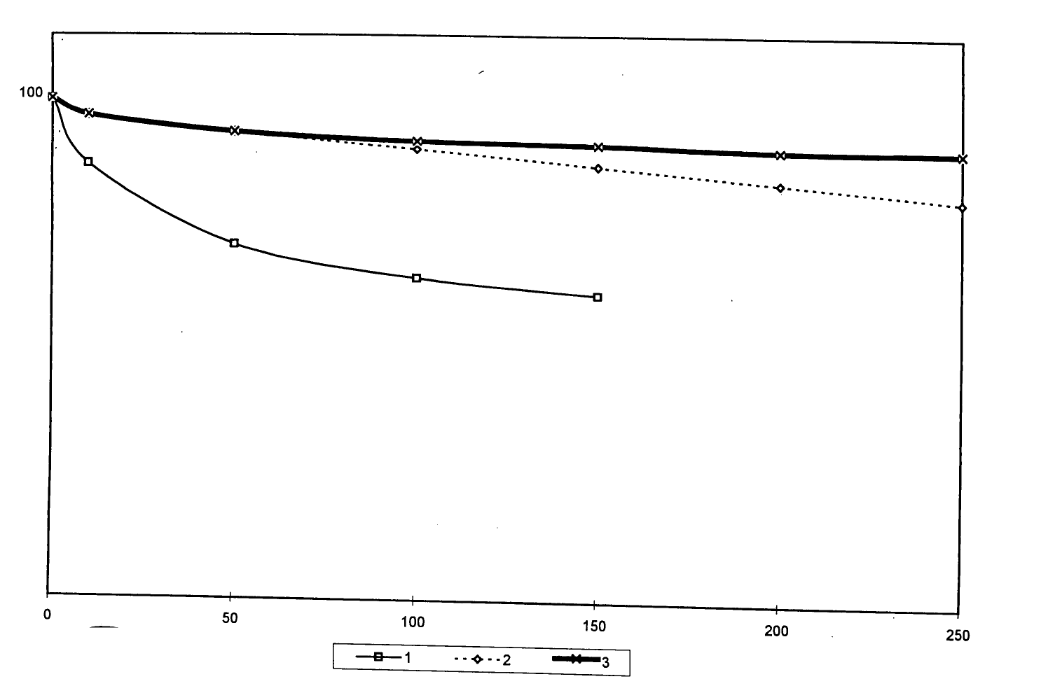

FIG. 1 shows the methane conversion versus run time for examples 1 to 3 (indicated as 1, 2 and 3, respectively). The Y axis shows, on a linear scale, the methane conversion relative to the initial methane conversion, which is set on 100. The X axis shows the hours on stream. It is clear that the catalyst in the form of the fixed arrangement of the invention (example 3) shows a higher stability (lower deactivation rate) than the catalysts containing either rhodium or iridium. In a commercial operation, the observed difference in stability means an important improvement.

1. A catalyst or a precursor therefor in the form of a fixed arrangement, wherein the fixed arrangement comprises at least two layers, the first layer comprising as a catalytically active metal or precursor therefor rhodium or a rhodium compound and the second layer comprising as a catalytically active metal or precursor therefor iridium, osmium or platinum or a compound thereof.

2. A catalyst or a precursor therefor according to claim 1, wherein the fixed arrangement is a fixed bed of particles.

3. A catalyst or a precursor therefor according to claim 1, wherein the fixed arrangement comprises as carrier a porous monolithic structure, preferably a ceramic foam.

4. A catalyst or a precursor therefor according to any preceding claim, wherein the length of the second layer is at least the length of the first layer and at most 50 times the length of the first layer preferably at least two times the length of the first layer, more preferably at least three times the length of the first layer, even more preferably at least four times the length of the first layer.

5. Catalyst particles or catalyst precursor particles comprising a first, outer layer comprising as a catalytically active metal or precursor therefor rhodium or a rhodium compound and a second layer comprising as a catalytically active metal or precursor therefor iridium, osmium or platinum or a compound thereof.

6. A catalyst or a precursor therefor according to any of claims 1 to 4, or catalyst (precursor) particles according to claim 5, wherein the catalytically active metal in at least one of the layers is associated with at least one inorganic metal cation or a precursor thereof in such a way that the inorganic metal cation is present in intimate association, supported on or with the catalytically active metal.

7. A catalyst or a precursor therefor or catalyst (precursor) particles according to claim 6, wherein the inorganic metal cation is selected from Groups IIA, IIIA, IIIB, IVA, IVB and the Lanthamides of the Periodic Table of the Elements, preferably is selected from Al, Mg, Zr, Ti, La, Hf, Si and Ba, more preferably is Zr.

8. A catalyst or a precursor therefor or catalyst (precursor) particles according to any of claims 1 to 7, wherein the second layer comprises iridium or an iridium compound.

9. A catalyst or a precursor therefor or catalyst (precursor) particles according to any of claims 1 to 8, wherein the catalytically active metal or precursor therefor is supported on an inorganic carrier material, preferably a refractory oxide, more preferably alumina, silica, zirconia, titania or a mixture thereof, still more preferably a (partially) stabilised zirconia.

10. A process for the catalytic partial oxidation of a hydrocarbonaceous feedstock, which process comprises contacting a feed comprising a hydrocarbonaceous feedstock and an oxygen-containing gas with a catalyst or with catalyst particles according to any of claims 1 to 9, preferably at a pressure in the range of from 1 to 150 bara, at a temperature in the range of from 750 to 1400° C., and at a gas hourly space velocity in the range of from 20,000 to 100,000,000 Nl/kg/h.

11. A process according to claim 10, wherein the hydrocarbonaceous feedstock is selected from methane, natural gas, associated gas, a source of light hydrocarbon, naphtha, LPG, middle distillates, kerosene, gasoil, oxygenates comprising alcohols, ethers, acids or esters, and mixtures thereof.

12. A process according to claim 10 or 11, wherein the hydrocarbonaceous feedstock and the oxygen-containing gas are present in amounts giving an oxygen-to-carbon ratio of from 0.3 to 0.8, preferably of from 0.45 to 0.75.

13. A process according to any of claims 10 to 12, wherein the feed is contacted with the catalyst at a to pressure of from 2 to 100 bara, preferably of from 5 to 50 bara.

14. A process according to any of claims 10 to 13, wherein the feed is contacted with the catalyst at a temperature of from 850 to 1350° C., preferably of from 900 to 1300° C.

15. A process according to any of claims 10 to 14, wherein the feed is contacted with the catalyst at a gas hourly space velocity of from 50,000 to 50,000,000 Nl/kg/h, preferably of from 500,000 to 30,000,000 Nl/kg/h.
